(19) United States
(12) Patent Application Publication
(10) Pub. No.: US 2012/0159824 A1
(43) Pub. Date: Jun. 28, 2012

(54) Frame backing system and method for assembling

(76) Inventor: Richard Emil Badwey, Arlington, VA (US)

(21) Appl. No.: 13/169,016

(22) Filed: Jun. 26, 2011

Related U.S. Application Data
(60) Provisional application No. 61/425,818, filed on Dec. 22, 2010.

(51) Int. Cl. A47G 1/06; B23P 17/00

(52) U.S. Cl. 40/718; 29/525.02

(57) ABSTRACT

The present invention is a frame backing system to frame an item utilized with a frame with a back that is attached to said back of frame that includes a pair of formed apertures that are horizontally aligned 180 degrees from each other across the back of the frame backing system, a pair of threaded inserts placed in the formed apertures and a piece of sealing paper with a width to protect and seal the item attached to the back of frame and a plurality of apertures that correspond to an orientation of the threaded inserts and the formed apertures disposed on the frame. The system also includes a coupling device with an additional corresponding aperture with a wire with two ends that runs across the width of the sealing paper.

This application claims priority to U.S. Provisional Application 61/425,818 filed on Dec. 22, 2010, the entire disclosure of which is incorporated by reference.

### TECHNICAL FIELD & BACKGROUND

The framing of pictures, artwork and other valuable items such as diplomas, is a complex and often expensive process due to the desires to protect the item being framed as well as to provide a finished, professionally framed product that is visually appealing. Current relative high quality systems and methods used for framing are utilized exclusively by a framing store or service and are not available to individuals.

It is an object of the present invention to provide a frame backing system that can be installed by an individual user.

It is an object of the present invention to provide a frame backing system kit that can be installed by an individual user.

It is an object of the present invention to provide a frame backing system that provides a professional quality frame without the added cost of using a professional framing store.

It is an object of the present invention to provide a method for assembling a frame backing system that can be assembled by an individual user or a professional framing store that is also required by the Library of Congress standards of framing as well as other related conservation organizations.

What is really needed is a frame backing system that can be installed by an individual user, a frame backing system kit that can be installed by an individual user, a frame backing system that provides a professional quality frame without the added cost of using a professional framing store and a method for assembling a frame backing system that can be assembled by an individual user or a professional framing store that is also required by the Library of Congress standards of framing as well as other related conservation organizations.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a front environmental perspective view of a framing backing system, in accordance with one embodiment of the present invention.

FIG. 1B illustrates a front perspective view of a formed aperture and a threaded insert of a frame backing system, in accordance with one embodiment of the present invention.

FIG. 1C illustrates a front overhead perspective view of a piece of sealing paper attached to a frame of a frame backing system, in accordance with one embodiment of the present invention.

FIG. 1D illustrates a front overhead perspective view of a piece of sealing paper attached to a frame of a frame backing system, in accordance with one embodiment of the present invention.

FIG. 1E illustrates a front perspective view of a second aperture formed on a piece of sealing paper and a coupling device of a frame backing system, in accordance with one embodiment of the present invention.

FIG. 2 illustrates a block diagram of a sealing and mounting kit and its components of a frame backing system, in accordance with one embodiment of the present invention.

FIG. 3 illustrates a flow chart of a method for assembling a frame backing system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

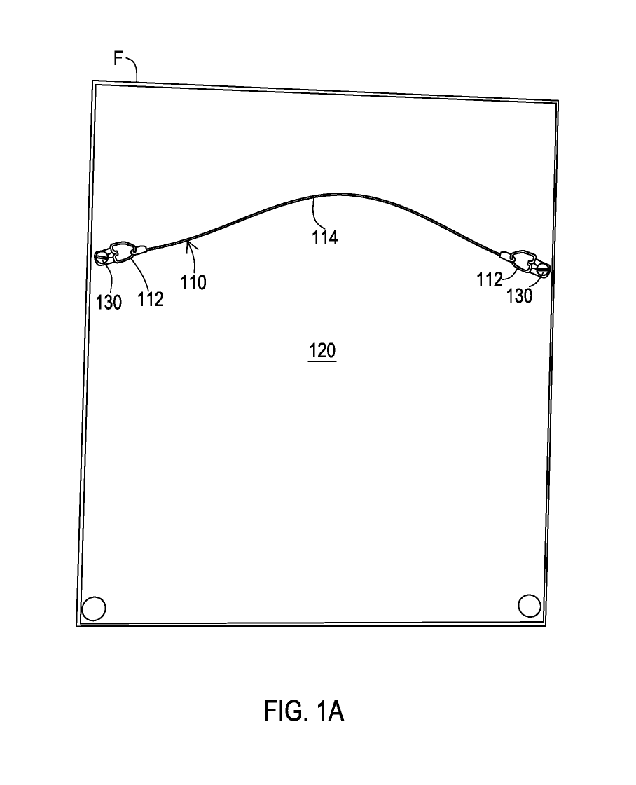

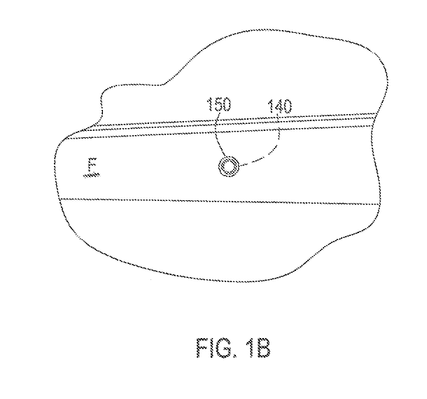

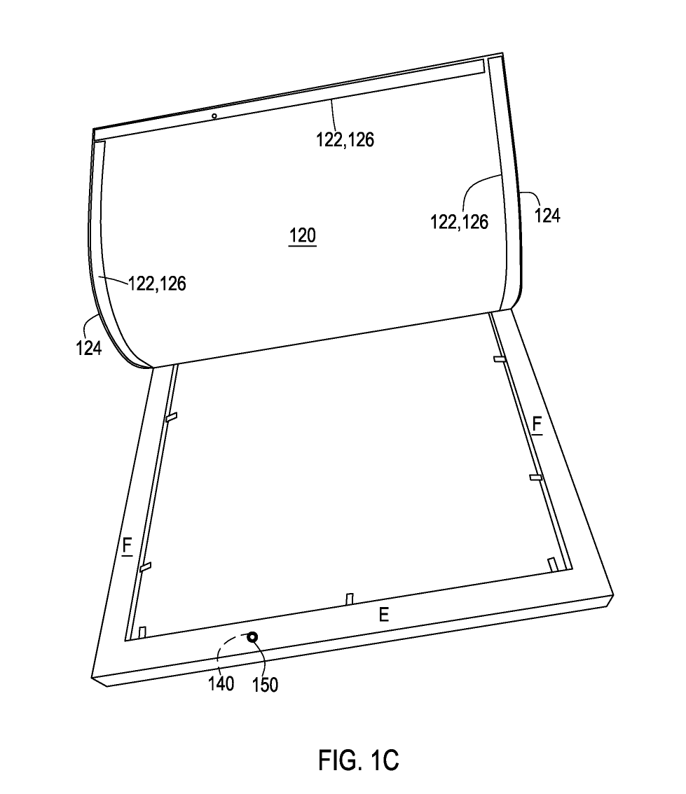

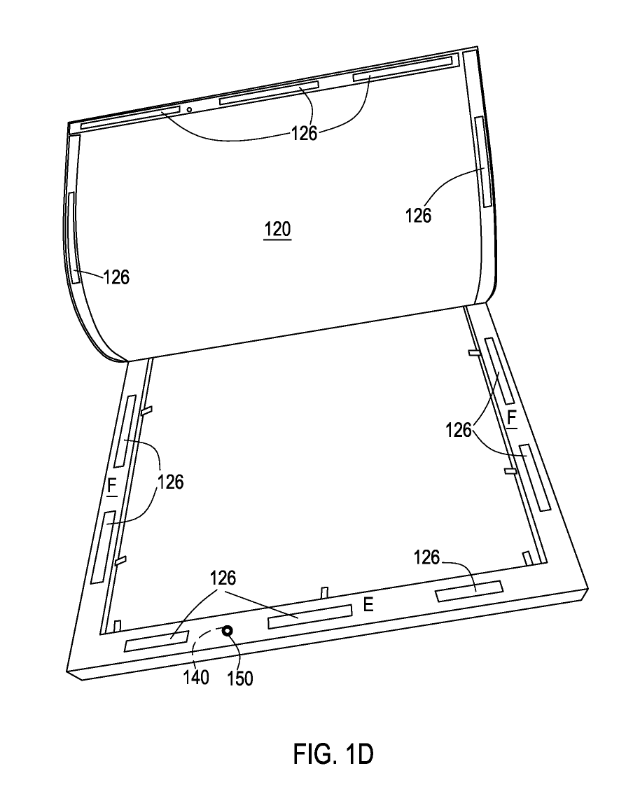

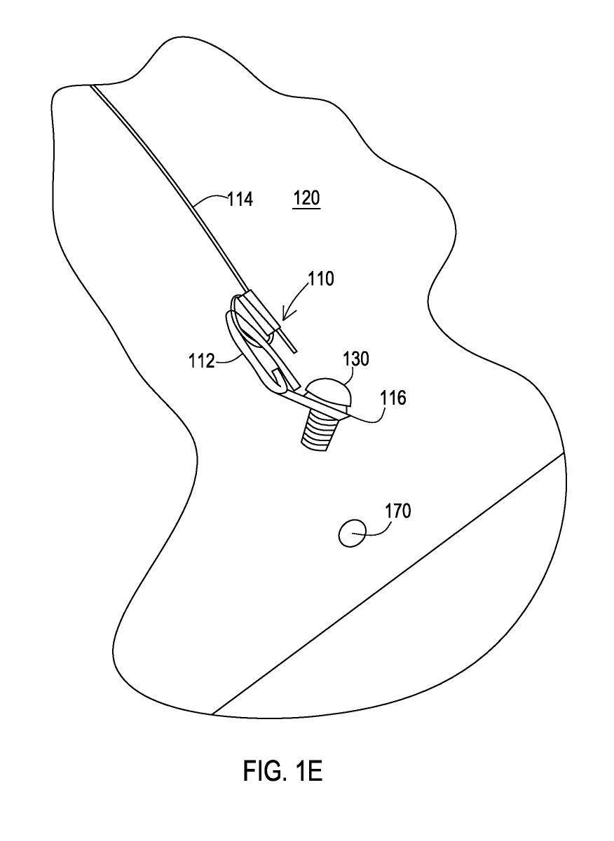

FIG. 1A illustrates a front environmental perspective view of a frame backing system 100, in accordance with one embodiment of the present invention. The frame backing system 100 includes a coupling device 110, a piece of sealing paper 120 and an attachment screw 130. The frame backing system 100 can be attached to the back of any suitable frame F that is frequently utilized to contain a piece of artwork, one or more photographs, a diploma or other suitable item. The frame F is defined as the enclosing area that is disposed around the perimeter of the item or object being framed. The frame F is typically made of wood, plastic or metal, although the frame F can also be made of other suitable materials. The coupling device 110 has a pair of flanges 112 with a wire 114 running horizontally across the width of the sealing paper 120 and the frame F. Further details regarding the coupling device are described in FIG. 1E and its description. The coupling device 110 allows a corresponding hanging device (not shown) such as a picture frame hook, a nail or a hanging protrusion to receive the coupling device 110 to hang the frame F and item on a surface, which is typically a vertical surface such as a wall. The sealing paper 120 is utilized to protect and seal the item being framed from dust, moisture, mold and other contaminants. The sealing paper 120 must be stable and easy for the user to handle and attach the sealing paper 120 to the back of the frame F. The sealing paper 120 can be made of acid free paper, cotton paper (also known as rag), a synthetic plastic such as TYVEK™ or TESLIN™ or any conservation grade or archival grade backing sheets. Further details regarding the sealing paper 120 are described in FIGS. 1C, 1D and 1E and their descriptions. The attachment screw 130 attaches the coupling device 110 to the frame F 100 as described in FIGS. 1B and 1E.

FIG. 1B illustrates a front perspective view of a formed aperture 140 and a threaded insert 150 of a frame backing system 100, in accordance with one embodiment of the present invention. The frame backing system 100 includes a formed aperture 140 and a threaded insert 150. The formed aperture 140 is disposed directly on the frame F and can be formed by drilling the formed aperture 140 or other suitable method for forming the formed aperture 140. The threaded insert 150 can then be screwed into the formed aperture 140 and is typically slightly smaller than the threaded insert 150 to form a relatively tight fit to secure the threaded insert 150 in place. Typically there are two formed apertures 140 that are disposed on the frame F that are horizontally aligned 180 degrees from each other across the width of the frame F, although other suitable orientations and numbers of formed apertures can also be utilized. The formed threaded apertures 140 can be disposed anywhere on the frame F, although typically they are disposed approximately on the top middle half TMH of the frame F. The threaded insert 150 is placed in the formed aperture 140 after forming the formed aperture 140. The threaded insert 150 can be made of brass, steel, nickel, copper, aluminum, magnesium, durable plastic or polystyrene or other suitable material. The threaded insert 150 is burrowed into the back of the frame F without drilling through the thickness of the frame F. The threaded insert 150 can include a threaded bushing, a threaded nut or any other internal threaded fastener to accommodate and contain the attachment screw 130 or other suitable fastening device that secures the frame backing system 100 in place, which is described further in the FIG. 1E description.

FIG. 1C illustrates a front overhead perspective view of a piece of sealing paper 120 attached to a frame F of a frame backing system 100, in accordance with one embodiment of the present invention.

The sealing paper 120 has an adhesive 122 disposed on a perimeter 124 of the sealing paper 120. The adhesive 122 can be any suitable type of adhesive for attaching a sealing paper to a frame. The adhesive 122 can also be disposed on the frame F or on the frame F and the perimeter 124 of the sealing paper. The frame backing system 100 and the sealing paper 120 can also utilize two sided tape 126 to attach the sealing paper 120 to the frame F.

FIG. 1D illustrates a front overhead perspective view of a piece of sealing paper 120 attached to a frame F of a frame backing system 100, in accordance with one embodiment of the present invention.

The sealing paper 120 has a plurality of corresponding magnetic strips 128 or other suitable form of magnetic material disposed on the perimeter 124 of the sealing paper and the frame F. The corresponding magnetic strips 128 disposed on the sealing paper 120 are attracted to the corresponding magnetic strips 128 disposed on the frame F to form a securing fastener 160 when brought close enough together. Both sets of magnetic strips 128 are made of pliable iron although the magnetic strips 128 can be made of other suitable types of materials.

FIG. 1E illustrates a front perspective view of an aperture 170 formed on a piece of sealing paper 120 and a coupling device 180 of a frame backing system 100, in accordance with one embodiment of the present invention.

The aperture 170 corresponds to the orientation of the threaded insert 150 and formed aperture 140 disposed on the frame F. There is also an additional aperture 170 that also horizontally corresponds to the orientation of the other threaded insert 150 and formed aperture 140 disposed on the frame F. The location of the threaded inserts 150 may be made apparent on the sealing paper 120 or may be marked, for example, by puncturing the paper over the location of the threaded inserts 150 and formed apertures 140. The attachment screws 130 are placed through a pair of coupling device apertures 116 and then are placed through the apertures 170 and are screwed into the threaded inserts 150. The coupling device 110 includes a pair of flanges 112 connected with a wire 114, although other suitable types of coupling devices can be utilized. The coupling device 110 should be relatively easy to use as well as protective of the item being framed.

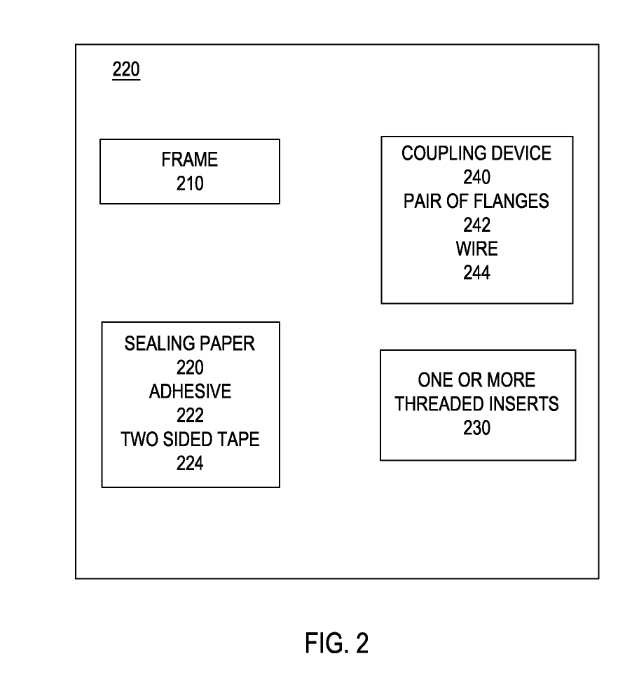

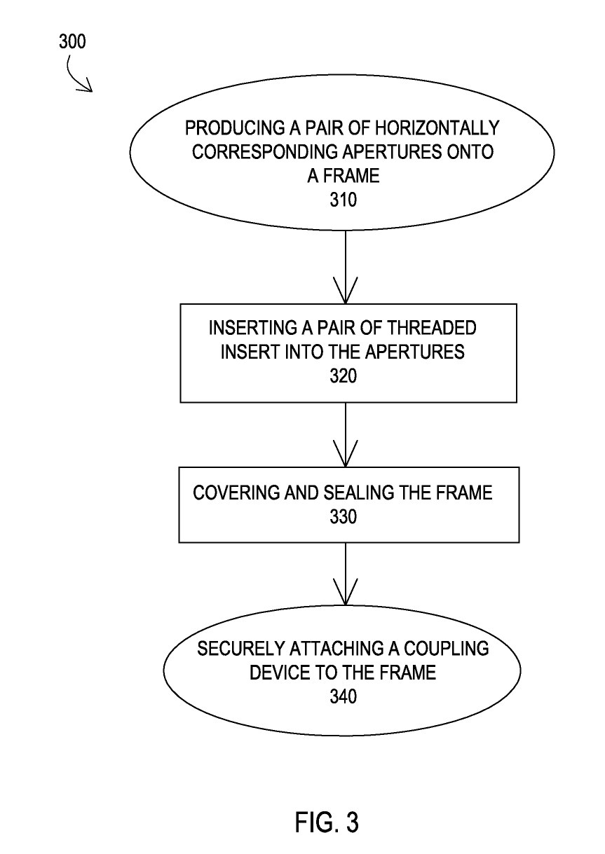

FIG. 2 illustrates a block diagram of a sealing and mounting kit 200 and its components of a framing backing system, in accordance with one embodiment of the present invention. The sealing and mounting kit may include a frame 210, a sealing paper 220 that can be coupled to the frame 210, for example by way of an adhesive 222 or two sided tape 224, one or more threaded inserts 230 and a coupling device 240 that can include a pair of flanges 242 connected by a wire 244. The sealing and mounting kit 200 utilizes the same previously mentioned corresponding components of the frame backing system 100 described and illustrated in FIGS. 1A-1E and their descriptions or can utilize other components of the frame backing system 100 as well and its method for assembling 300, which is further discussed in FIG. 3.

FIG. 3 illustrates a flow chart of a method for assembling 300 a frame backing system, in accordance with one embodiment of the present invention. The method for assembling 300 a frame backing system includes producing a pair of horizontally corresponding apertures onto a frame 310, inserting a threaded insert into each of the produced apertures 320, covering and sealing the frame with a piece of attached sealing paper 330 and securely attaching a coupling device to the frame 340.

The step of producing the apertures 310 includes drilling the apertures or screwing the threaded inserts into the frame forming the apertures by displacement of the threaded insert forming the aperture. The step of inserting the threaded inserts into the apertures 320 includes inserting the threaded inserts into the apertures that are slightly smaller than the threaded inserts to ensure the threaded inserts are tightly held within the apertures by the pressure from the threaded insert against the inner walls of the apertures. The step of covering and sealing the frame 330 includes attaching the sealing paper with a fastener selected from the group consisting of a plurality of corresponding magnets, adhesive or a plurality of strips of two sided tape. The step of securely attaching a coupling device to the frame 340 includes utilizing a pair of flanges disposed on two ends of a wire of the coupling device. Corresponding orientations of the threaded inserts are indicated on the sealing paper by a pair of corresponding indicia and producing a second aperture on the indicia. The attachment screws are then inserted through the flanges, the indicia and the threaded inserts securing the frame backing system to the frame. The method for assembling 300 is then completed.

The frame backing system utilizes a threaded insert that may be inserted into a back portion of a frame by drilling or screwing the threaded insert into the frame. A corresponding threaded insert may then be inserted horizontally across the opposite side of the frame. The frame may then be covered by a piece of sealing paper and may be coupled to the frame by utilizing an adhesive disposed on the frame itself, an adhesive correspondingly disposed on the paper, an adhesive disposed on both the sealing paper and the frame, a plurality of magnets disposed on the frame and a plurality of magnets correspondingly disposed on the paper forming a magnetic attachment or two sided tape disposed on the frame or sealing paper. This may then seal the frame and any object inside the frame which is desired to be displayed.

After sealing the frame, a coupling device, which may include a pair of flanges connected with a wire, may then be coupled to the frame. The ends of the coupling device may be placed over the threaded inserts that were previously inserted into the frame. The location of the threaded inserts may be indicated on the sealing paper by corresponding indicia made such as an “X” or other suitable indicia or by puncturing the paper over the location of the threaded inserts. Attachment screws may then be inserted through the ends of the flanges and into the threaded inserts and the coupling device may then be securely coupled to the frame via the threaded inserts.

Following the secure coupling of the coupling device to the frame, suitable planar desired contents such as one or more pictures, a piece of artwork or a diploma can then be displayed within the frame and may be effectively sealed from outside elements and may be prepared for hanging, display, storage or any other desired use.

In another exemplary embodiment, a sealing and mounting kit for a frame may be assembled utilizing the method for assembling. The sealing and mounting kit may include a frame, a sealing paper that can be coupled with a frame, for example by way of an adhesive, one or more threaded inserts, a plurality of magnets or two sided tape and a coupling device that can include a pair of flanges connected by a wire. The sealing and mounting kit may be utilized and sold as a frame backing system and can be utilized in combination with a method for framing objects in the frame backing system.

The frame backing system was introduced at a tradeshow where 10 to 15 frame backing systems were sold. Additionally after the tradeshow, additional frame backing systems were sold to a few existing clients who enjoyed the frame system and reordered more frame backing systems. The frame backing systems were typically desired by collectors who had important letters they wanted to frame but were concerned with either shipping their items or entrusting them to a local framer. The collectors ordered the size and color of the frame backing system they needed, which was then packaged and shipped to them. A website is currently being prepared to sell the frame backing system based on the relative success from the tradeshow and relatively strong local sales.

Over the past few years several different hanging and mounting systems have been experimented with in reducing the current frame backing system and method for assembling to practice. One experiment utilized a thick archival board on the back of a frame as a covering. The problem with this was the difficulty in removing the mats and backings from the frame since there needs to be some flexibility with the back dust cover, in order to gain access to the mats and backings.

It was realized in developing the frame backing system that the end user can relatively easily utilize the frame backing system. The frame backing system was so easy to utilize, people not familiar with the frames or the framing industry utilized the frames in mounting and sealing their valuable documents and diplomas without any difficulty.

The purpose of mounting and framing the item to be framed is to allow safety and protection in preserving the item for many years to come. A frame backing system and method for assembling the frame backing system had to be devised to make the entire process user friendly to the novice user. After months of experimenting, the frame backing system and method for assembling was developed to make it relatively simple for an end user to assemble the frame backing system themselves that utilizes the method for assembling which is also safe for the item being framed.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A frame backing system to frame an item utilized with a frame with a back that is attached to said back of frame, comprising:
a pair of formed apertures that are horizontally aligned 180 degrees from each other across said back of frame;
a pair of threaded inserts placed in said formed apertures;
a piece of sealing paper with a width to protect and seal said item attached to said back of frame and a plurality of apertures that correspond to an orientation of said threaded inserts and said formed apertures disposed on said frame;
a coupling device with a pair of flanges with a pair of additional corresponding apertures with a wire with two ends that runs across said width of said sealing paper and said frame that attaches said frame backing system to a corresponding hanging device, wherein said additional corresponding apertures are disposed on said ends of wire; and
a pair of attachment screws that are sequentially inserted through said additional coupling device apertures said sealing paper apertures and into said threaded inserts securing said frame backing system to said frame.

2. The system according to claim 1, wherein said formed apertures are slightly smaller than said threaded insert to form a tight fit to secure said threaded insert.

3. The system according to claim 1, wherein said threaded inserts are made of material selected from the group consisting of brass, steel, nickel, copper, aluminum, magnesium, durable plastic or polystyrene.

4. The system according to claim 1, wherein said sealing paper is attached to said frame with an adhesive.

5. The system according to claim 1, wherein said sealing paper is attached to said frame with two sided tape.

6. The system according to claim 1, wherein said sealing paper is attached to said frame with a plurality of magnetic strips.

7. The system according to claim 1, wherein said sealing paper is made of material selected from the group of acid free paper, cotton paper, synthetic plastic paper, any conservation grade backing sheet or any archival grade backing sheet.

8. The system according to claim 1, wherein said frame is made of material selected from the group consisting of wood, plastic or metal.

9. A sealing and mounting kit that includes a plurality of components from a frame backing system, comprising:
a frame;
a piece of sealing paper that is coupled to said frame;
one or more threaded inserts that are inserted into one or more threaded apertures formed on said frame; and
a coupling device with a pair of flanges each with an additional corresponding aperture with a wire with two ends that runs across said width of said sealing paper and said frame that attaches said frame backing system to a corresponding hanging device, wherein said additional corresponding apertures are disposed on said ends of wire.

10. The kit according to claim 9, wherein said frame is made of material selected from the group consisting of wood, plastic or metal.

11. The kit according to claim 9, wherein said frame is coupled to said sealing paper with an adhesive.

12. The kit according to claim 9, wherein said frame is coupled to said sealing paper with two sided tape.

13. The kit according to claim 9, wherein said threaded inserts are made of material selected from the group consisting of brass, steel, nickel, copper, aluminum, magnesium, durable plastic or polystyrene.

14. A method for assembling a frame backing system, comprising:
producing a pair of horizontally corresponding apertures onto a frame;
inserting a threaded insert into each said produced aperture;
covering and sealing said frame with a piece of attached sealing paper; and
securely attaching a coupling device to said frame.

15. The method according to claim 14, wherein said producing said apertures includes drilling said apertures or screwing said threaded inserts into said frame forming said apertures by displacement of said threaded insert forming said apertures.

16. The method according to claim 15, wherein said apertures are drilled slightly smaller than said size of said threaded inserts.

17. The method according to claim 14, wherein said sealing paper is attached with a fastener selected from the group consisting of a plurality of corresponding magnets, adhesive or a plurality of strips of two sided tape.

18. The method according to claim 14, wherein said coupling device is a pair of flanges disposed on two ends of a wire.

19. The method according to claim 14, wherein a corresponding orientation of said threaded inserts are indicated on said sealing paper by a pair of corresponding indicia and producing a pair of second apertures on said pair of indicia.

20. The method according to claim 14, wherein said attachment screws are inserted through said flanges, said indicia and said threaded inserts.
